(19) United States
(12) Patent Application Publication
(10) Pub. No.: US 2003/0172050 A1
(43) Pub. Date: Sep. 11, 2003

(54) System and method for monitoring a network site for linked content

(76) Inventors: Jerry B. Decime, Eagle, ID (US); Jason C. Crawford, Boise, ID (US); Marcus Richard Nilson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/093,284

(22) Filed: Mar. 6, 2002

(51) Int. Cl. G06F 7/00

(52) U.S. Cl. 707/1

(57) ABSTRACT

A method of monitoring a network site includes searching a network site to identify any objectionable content associated with a network page link on the network site, and responding to the identified network page link. A network site monitoring system comprises a network site configured for displaying at least one network page link on a network page, and a monitor configured for identifying objectionable network page links on the network site.

### THE FIELD OF THE INVENTION

The present invention relates to network sites and in particular to monitoring network sites for linked content.

### BACKGROUND OF THE INVENTION

With the advent of the internet, people can readily obtain information for almost any purpose. For many computer users, accessing a web site on the Internet provides quick access to information. A web site for a particular company commonly includes links, such as uniform resource locator (URL) addresses, to other web sites and web pages external to the company's web site to conveniently allow a user to obtain further information.

Unfortunately, ownership of an external web site can change hands without notice to the company web site that lists a link to the external web site. With such changes, the external web site's content may change to objectionable content that is either irrelevant to the purpose of the company web site and/or obscene, immoral, etc. As a consequence, with the link to the external web site remaining on the company web site, the company web site unknowingly provides a link to objectionable content for the user. This situation is at the best, merely embarrassing, and at the worst, the basis for legal action against the company and damaging to the company's reputation.

Linking to external web sites is a useful part of commerce on the Internet. On the other hand, the unbounded nature of linking through those external web site links, exposes a web site to association with objectionable content. Accordingly, operators of web sites face an ongoing struggle of using linking to associate their web site with useful external web sites while safeguarding their web sites against unwanted association with inappropriate external web sites.

### SUMMARY OF THE INVENTION

A method of the present invention of monitoring a network site includes searching a network site to identify any objectionable content associated with a network page link on the network site, and responding to the identified network page link. A network site monitoring system of the present invention comprises a network site configured for displaying at least one network page link on a network page, and a monitor configured for identifying objectionable network page links on the network site.

### BRIEF DESCRIPTION OF THE DRAWINGS

FIG. 1 is a block diagram of a system for monitoring a network site, according to an embodiment of the present invention.

FIG. 2 is flow diagram of a method of monitoring a network site, according to an embodiment of the present invention.

FIG. 3 is a block diagram of an internal network page, according to an embodiment of the present invention.

FIG. 4 is a block diagram of a list of network page links, according to an embodiment of the present invention.

FIG. 5 is a block diagram of an external network page, according to an embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the present invention may be implemented in hardware via a microprocessor, programmable logic, or state machine, in firmware, or in software within a given device. In one aspect, at least a portion of the software programming is web-based and written in HTML and JAVA programming languages, including links to graphical user interfaces, such as via windows-based operating system. The components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employ a graphical user interface windowing environment which presents the applications or documents in specially delineated areas of the display screen called “windows”. The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

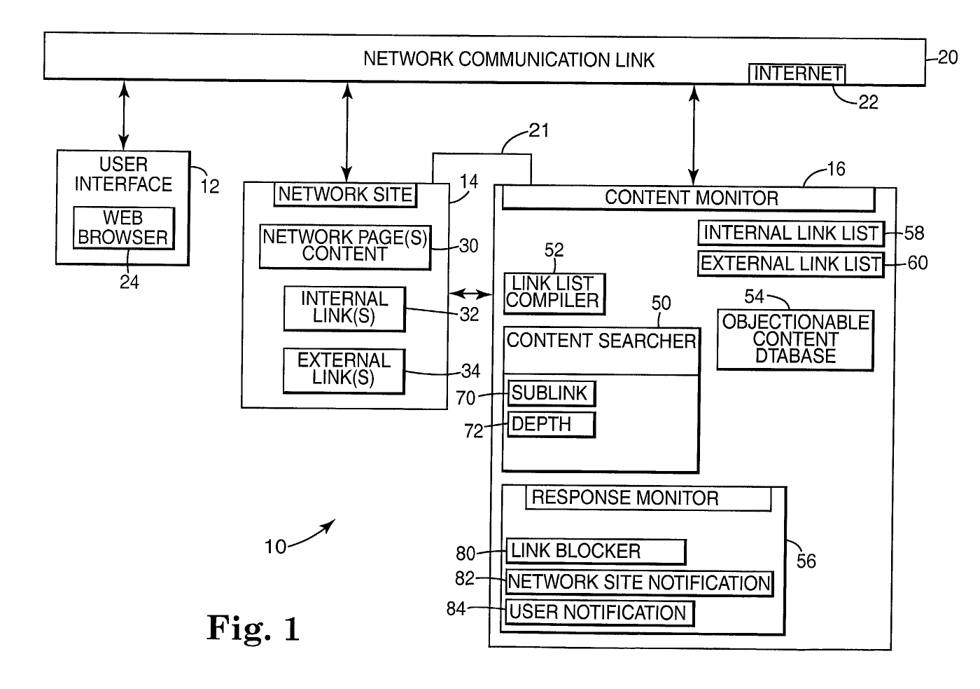

A system and method for monitoring network sites, such as web sites, monitors a network site to identify objectionable network page links and content on the network site and take action regarding the identified network page links. A system 10 for monitoring a network site, in one exemplary embodiment of the present invention, is illustrated in FIG. 1 generally at 10. As shown in FIG. 1, system 10 includes user interface 12, network site 14, content monitor 16, and network communication link 20 with Internet link 22. User interface 12 optionally includes web browser 24. Network site 14 includes network page content 30 (e.g. web pages), internal network page links 32 and external network page links 34.

As further shown in FIG. 1, content monitor 16 includes content searcher 50, link list compiler 52, objectionable content database 54, response monitor 56, and internal link list 58 and/or external link list 60. Content searcher 50 includes sublink module 70 and depth module 72 while response monitor 56 includes link blocker 80, network site notification module 82, and user notification module 84.

Web browser 24 of user interface 12 preferably comprises an internet browser such as Internet Explorer® or Netscape Navigator®, or other system for generating visual objects such as text, objects, and graphical user interface objects, that can be activated and deactivated with a pointing device. Web browser 24 preferably further comprises web browser software supported by any one of several computer system platforms such as Windows, Macintosh, Unix, Linux, and other platforms capable of executing web browser software that provides HTTP (Hyper Text Transfer Protocol) client functions and that renders HTML (Hyper Text Markup Language) files. However, user interface 12 optionally includes other client or terminal interfaces for communicating and computing with network site 14.

Network site 14 preferably comprises a network site configured for supplying documents to provide user interface 12 with information on a particular topic. For example, network site 14 preferably comprises a product support web site devoted to providing a user information about a product and/or technical support through a compilation of web pages 30, and links to other web pages, displayed at web browser 24. The web page links include links to web pages located internally within network site 14, such as internal network page links 30, as well as links to web pages located externally of network site 14, such as external network page links 34. Using these links, the universe of documents provided through network site 14 to user interface 12 is controlled by an administrator of network site 14.

To enable the network site administrator to provide the user with only acceptable content pertinent to the purpose of network site 14, content monitor 16 cooperates with network site 14, either as part of network site 14, or as an independent entity in communication with network site 14. Content monitor 16 is configured to systematically identify network page links, and their associated network pages, that have content objectionable to network site 14 and notify an administrator of network site 14 so that appropriate action regarding the network page link can be taken. With this system and method, the network site administrator need not continually, manually review each network page link on network site 14 for objectionable content.

Content searcher 50 of content monitor 16 includes a search engine equipped to search through network site 14, including all its network pages, and identify network page links, such as uniform resource locator addresses, internet protocol (IP) addresses, or any other type of address that produces an activatable link from a network page to another network page. With its search engine, content searcher 50 is also equipped to identify objectionable content within the identified links and/or network pages and html files associated with those links.

Content searcher 50 includes sublink module 70 and depth module 72. Sublink module 70 is selectively activatable to focus content searcher 50 to search for sublinks within the network pages of network page links on network site 14 while depth module 72 is also selectively activatable to control the degree of sublinking that will be searched by sublink module 70. In other words, as one link leads to other links, each subsequent link represents a degree of linking between network pages. Each degree of linking represents the extent to which a network page is remotely associated with network site 14, with a greater degree of linking being typically representative of network pages that are completely unrelated to network site 14.

Link list compiler 52 of content monitor 16 compiles a list of network page links that are identified from content searcher 50 as being network page links. After a first list of all network page links is compiled, that list is searched again by content searcher 50 to identify any objectionable content in the links, and/or network pages associated with the links.

Objectionable content database 54 of content monitor 16 includes a list of words, phrases, symbols, image identifiers, etc. that represent ideas, images, thoughts, etc. that are objectionable to the interests and purposes of network site 14, either as being irrelevant and/or obscene. The list in database 56 is controlled by network site 14, or an independent operator of content monitor 16, and is shaped to target any material that is deemed unsuitable for association with network site 14, such as irrelevant material, obscene material, and/or other material which optionally includes competitive information, advertising, information critical of network site 14 or its sponsor, etc. This content database does not contain a list of actual URLs that contain objectionable material, only triggers that are used to identify target sites that contain objectionable material as identified in the database.

Internal link list 58 of content monitor 16 is a list of network page links, such as uniform resource locator (URL) addresses, located within network site 14 while external link list 60 is a list of network page links, such as uniform resource locator (URL) addresses, to network pages located externally of network site 14. Each list 58,60 is created through link list compiler 52. Once created, these lists can be used cooperatively with link list compiler 52 to track, over a period of time, the number and type of network page links appearing on network site 14. These lists can make it easier to spot the posting of inappropriate links. For example, content searcher 50 could be used to compare any new link with links on the lists 58,60 to determine if a content search is warranted. However, content monitor 16 is preferably used to comprehensively search network site 14 each day for all internal and/or external links to insure that no objectionable content has appeared in both previously acceptable network page links and new network page links, and their associated network pages.

Response monitor 56 of content monitor 16 enables network site 14 to respond to identification of an objectionable network page link. Link blocker 80 of response monitor 56 is optionally triggered by an administrator of network site 14 to prevent activation by a user of an objectionable network page link. Network site notification module 82 notifies administrator of a link identified as being objectionable, so that the administrator can investigate the link and take appropriate action such as requesting removal of the objectionable content or removing the link. Upon identification of an objectionable link, user notification module 84 of response monitor 56 is optionally employed by network site 14 to notify a user upon attempted activation of a network page link that the link may contain objectionable material and that the administrator of network site 14 is taking action regarding the objectionable material. Of course, the method and system is not limited to solely these responses, as other mechanisms for neutralizing the objectionable content in response to identified link may be used.

Content monitor 16 optionally stands independent of network site 14 and is linked to network site 14 through network communication link 20 and/or direct link 21. Content monitor 16 is optionally provided as a service by a service provider to network site 14.

Network communication link 20, as used herein, includes an Internet communication link (e.g., the Internet), an intranet communication link, or similar high-speed communication link. In one preferred embodiment, network communication link 20 includes an Internet communication link 22. Network communication link 20 permits communication between user interface 12 (including web browser 24), network site 14, and content monitor 16.

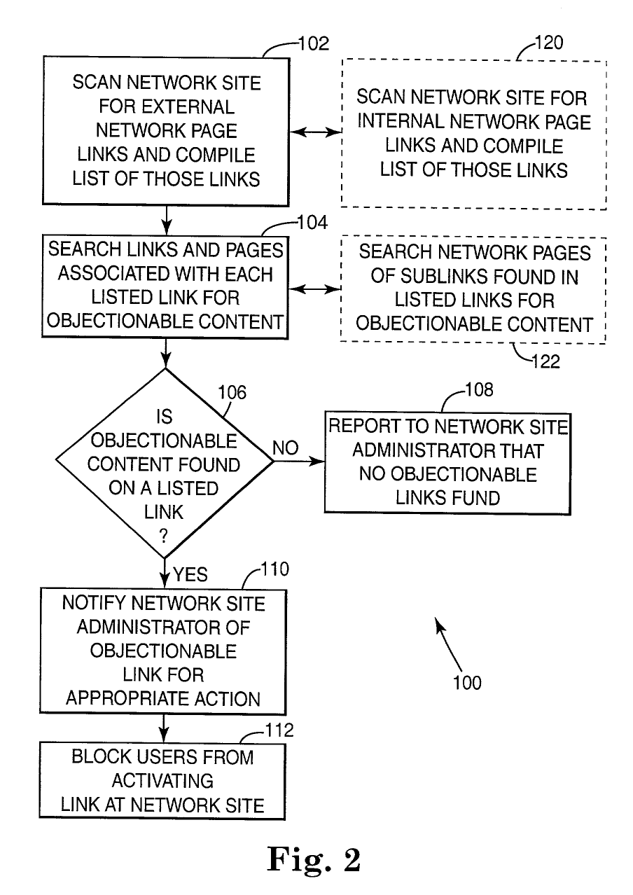

FIG. 2 illustrates a method 100 of monitoring network site 14, according to one embodiment of the present invention. As shown in FIG. 2, method 100 includes first step 102 of scanning network site 14 for external network page links, such as uniform resource locator links, and compiling a list of those links. Step 102 preferably employs content searcher 50 (FIG. 1) to identify all network page links and employs link list compiler 52 to form a list of those links. An external network page link preferably is a uniform resource locator address that maps to a network page, such a hypertext markup language (HTML) file commonly known as a web page that is provided externally of network site 14.

The next step 104 of method 100 includes searching each network page link, and their associated network pages, to determine if the links and their associated network pages contain objectionable content. This step is preferably performed using content searcher 50 of content monitor 16. Objectionable content could appear in any or all of the following: the network page link (e.g. uniform resource locator address), the network page contents, meta tags of the network page, network page links listed on the network page (i.e. sublinks), etc. Objectionable content includes that material defined in objectionable content database 56 (FIG. 1), which is determined by network site 14, or administrator of content monitor 16.

For each network page searched, a query is made whether any objectionable content is found in association with the listed network page link (step 106). If no objectionable content is found, then a report is made to an administrator of network site 14 that no objectionable content was found in the listed network page links (step 108). On the other hand, if objectionable content was found on a network page link, and/or network page associated with the link, then system 10 notifies the administrator of the network site 14 of the objectionable network page link and to take appropriate action (step 110). In each case, method 100 preferably uses response monitor 56 of content monitor 16 to take the action.

Step 110 is optionally followed by step 112 in which users on the network site 14 are blocked from activating any network page link containing objectionable content.

Method 100 also includes other optional steps. For example, optional step 120 is performed along with step 102 and includes scanning network site 14 for internal network page links and compiling a list of those links. This compiled list of internal network page links would then be searched as part of step 104.

Method 100 also includes another optional step 122 that is performed in association with step 104, and includes searching network pages of sublinks found within the compiled list of network page links to determine if any of the sublinks, and their associated network pages, contain objectionable content. Sublink module 70 of content searcher 50 preferably is used to perform this step. Moreover, as preferably performed with activation of depth module 72, searching the sublinks also optionally includes selectively searching network page links contained within the network pages associated with the sublinks, so that the search penetrates through as many degrees of linking as necessary to insure that no objectionable content will be found through a given chain of links. Accordingly, method 100 facilitates monitoring network site 14 for objectionable content to safeguard network site 14 from undesirable links and/or content.

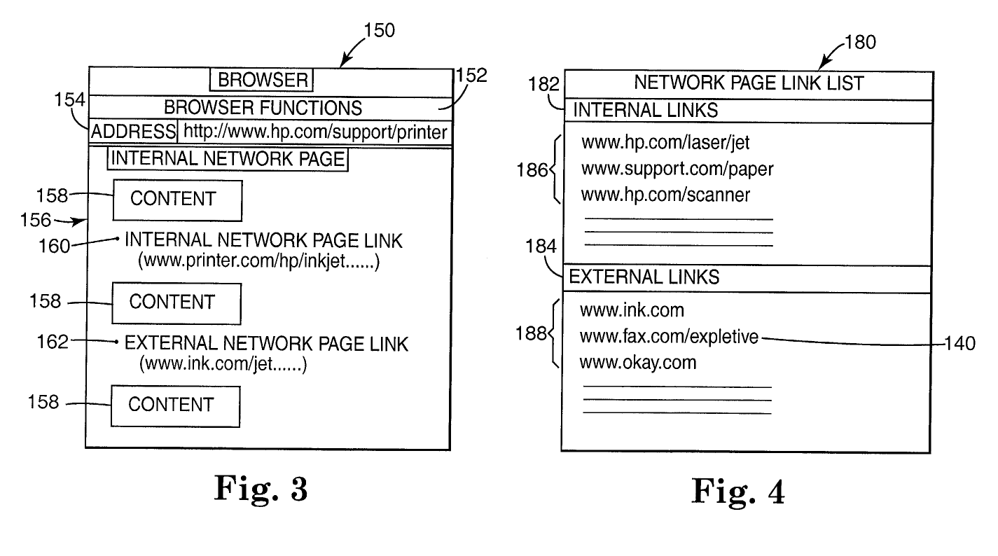

To further illustrate method 100 and system 10 in operation on network site 14, FIG. 3 illustrates network browser 150 displaying an internal network page of network site 14. As shown in FIG. 3, network browser 150 includes browser functions 152 (e.g., Back, Forward, etc,) address function 154, and internal network page 156 such as an internal web page. Web browser 150 has substantially the same features and attributes as web browser 24, previously described in association with FIG. 1. Internal network page 156 includes content 158, as well as internal network page link 160 and external network page link 162. Internal network page link 160 provides an activatable link to a network page located internally within network site 14 and controlled by network site 14. Internal network page link preferably is provided by an uniform resource locator address, such as www.printer.com/hp/inkjet . . . . External network page link 162 provides an activatable link to a network page located externally outside of network site 14 wherein the contents of the link 162 and all network pages associated with link 162 are not controlled by network site 14. External link 162 is provided as a courtesy by network site 14 to provide its users with convenient access to information and/or products of third party vendors or resources. External network page link 162 preferably is provided by an uniform resource locator address, such as www.ink.com/jet . . . .

Method 100 and system 10 are directed to insuring appropriate material on internal web page 156, whether the material is associated with content 158, internal network page link 160, and/or external network page link 162 to material located outside the control of network site 14. Accordingly, content monitor 16 acts on content 158 and links 160,162 to identify objectionable content.

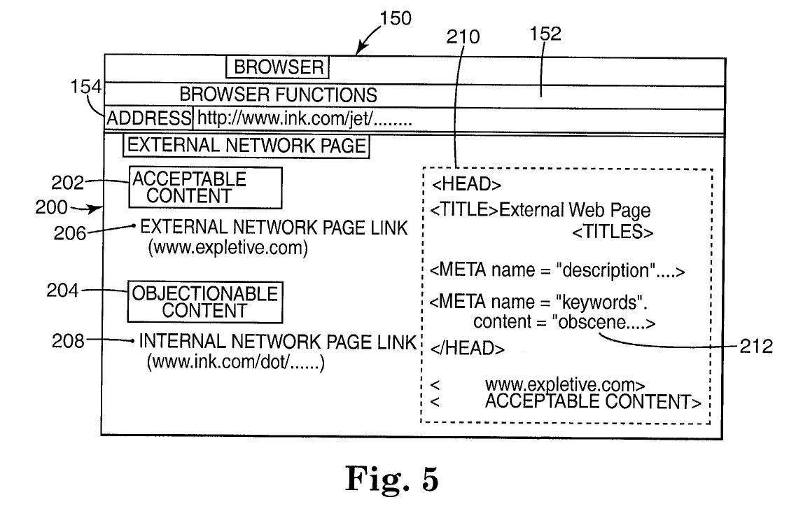

As a further example, FIG. 4 illustrates list 180 of compiled network page links that are created as part of method 100 in monitoring network site 14 including internal network page 156. As shown in FIG. 4, list 180 includes all internal network page links 182 and external network page links 184 that are contained with network site 14. Producing list 180 corresponds to the result obtained by performing steps 102 and/or 120 of method 100 (see FIG. 2), in association with link list compiler 52.

Internal links 186 include network page links, such as uniform resource locator addresses, that map to network pages located internally within network site 14. External links 188 include network page links, such as uniform resource locator addresses, that map to network pages located externally outside of network site 14. In the examples shown, one of the external links 188, link 190 bearing URL www.fax.com/expletive, includes objectionable content in the external link 140 itself and likely includes objectionable content in the network pages associated with link 140.

In using method 100, external network page link 162 on internal network page 156 was identified by content searcher 50 as a link, and then link 162 was activated to view its associated network page(s). In particular, FIG. 5 illustrates web browser 150 as it displays external network page 200 associated with external network page link 162 (FIG. 3). Accordingly, the user of browser 150 arrived at external network page 200 by activating link 162 that appeared on internal network page 156 of network site 14. As shown in FIG. 5, web browser 150 includes browser functions 152 and address function 154, as previously described in association with FIG. 3. External network page 200 includes acceptable content 202, objectionable content 204, external network page link 206 (e.g., www.expletive.com), internal network page link 208 (e.g., www.ink.com/dot/. .), and HTML file content 210.

HTML file content 210 represents any html language and/or functions that are found within the web page structure that is not seen by the user but which supports visible aspects of external web page 200. Where external web page 200 contains objectionable content, HTML file content 210 typically also includes objectionable content. In some cases, on their faces, internal network pages 156 and/or external network pages 200 will not include any objectionable content. However, HTML file content 210 associated with those apparently acceptable web pages can contain objectionable content in HTML comments and/or meta tags 212, which is likely unacceptable to the owner/operator of network site 14. Meta tags 212 enable an operator of a network page to draw users to that network page by specifying keywords that will be identified by search engines, so that the network page is returned as a search result on a search for that keyword(s). The keyword(s) may or may not be part of the actual displayed content of the network page. Meta tags are notoriously used by operators of network sites and network pages that have objectionable content.

As identified by content searcher 50, external network page 200 includes objectionable content including such words as “expletive”, and other words, images, etc, labeled as objectionable content 204. Upon finding a network page link such as external network page link 162 (and/or external network page 200 associated with a link), that includes objectionable content, the address of the link is identified to an administrator of network site 14 for appropriate action to be taken. Response monitor 56 of content monitor 16 is preferably employed to take action such as blocking the offending link from being displayed or activated at network site 14 (using link blocker 80), contacting the owner/operator of the offending link to remedy the problem, and/or immediately removing the offending link from network site 14.

A method and system of the present invention for monitoring a network site simplifies and enhances network site management. First, network page links are comprehensively compiled to identify links associated with objectionable content so that the links can be removed or otherwise dealt with. This system does not rely on the web browser or user to police whether or not they see objectionable content and gives the administrator of a network site more certainty of having a network site that is as free as possible from network page links, and network pages, that bear objectionable content. The system and method can be implemented as part of network site and/or implemented independently by a service provider as a service to network site. The system and/or method is preferably implemented in continuous operation, although it can be selectively activated or deactivated at the discretion of the network site administrator.

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of monitoring a network site, the method comprising:
searching a network site to identify any network page link on the network site that is associated with objectionable content; and
responding to identification of any network page link on the network site that is associated with objectionable content.

2. The method of claim 1 wherein searching the network site comprises:
searching at least one of an external web page link and an internal web page link on the network site.

3. The method of claim 1 wherein responding to the identification comprises at least one of:
notifying an administrator of the network site of the identified network page link associated with objectionable content;
blocking the identified network page link from being activated from the network site; and
contacting an operator of the identified network page link to request removal of the objectionable content.

4. The method of claim 1 wherein searching a network site includes:
identifying as objectionable content any words, symbols, and image identifiers, in an uniform resource locator address of the network page link.

5. The method of claim 1 wherein searching a network site includes:
identifying as objectionable content any words, symbols, and image identifiers, in a network page associated with the network page link and accessible through activation of the network page link.

6. A method of monitoring a network site, the method comprising:
scanning a network site for any network page links and compiling a list of those links;
determining whether each network page associated with the listed links includes objectionable content; and
compiling a list of each network page identified as having objectionable content.

7. The method of claim 6 wherein scanning a network site comprises:
scanning the network site for internal network page links.

8. The method of claim 6 wherein scanning a network site comprises:
scanning the network site for external network page links.

9. The method of claim 6 wherein determining whether each page includes objectionable content comprises:
searching the listed network page links for network page sublinks and identifying any objectionable content in the network page sublinks and in any network pages associated with the network page sublinks.

10. The method of claim 6 wherein determining whether each page includes objectionable content comprises:
searching the network page for any hypertext markup language file content and any meta tags that include objectionable content.

11. The method of claim 6 and further comprising:
notifying the administrator of the compiled list of network page links that include objectionable content.

12. The method of claim 6 and further comprising:
blocking users from activating network page links at the network site that have objectionable content.

13. A method of insuring appropriate web page links on a web site, the method comprising:
repeatedly searching the web site to identify objectionable web page links; and
taking action at the web site regarding the identified objectionable web page link.

14. The method of claim 13 wherein taking action comprises at least one of:
notifying an administrator of the web site of the identified web page link associated with objectionable content;
blocking the identified web page link from being activated from the web site; and
contacting an operator of the identified web page link to request removing the objectionable content.

15. A method of monitoring a network site comprising:
scanning every external network page link of a network site to identify each external network page associated with the network site;
activating each external network page link on the network site to access an external network page associated with the activated external network page link;
searching each external network page to identify objectionable content; and
notifying an administrator of each external network page that includes objectionable content.

16. The method of claim 15 and further comprising:
searching each network page link, including an uniform resource locator address of the link, for objectionable content in the link.

17. The method of claim 15 wherein identifying objectionable content includes identifying any words, symbols, and image identifiers that are irrelevant, obscene or immoral relative to the purposes of the web site.

18. A method of monitoring a web site comprising:
scanning every hypertext markup language file of the web site to identify each external uniform resource locator address on the network site;
activating each external uniform resource locator address on the network site;
searching each external hypertext markup language file produced by activation of each uniform resource locator address to identify objectionable content; and
notifying an administrator of the network site of each external html file that includes objectionable content and that was accessed by activating an external uniform resource locator address on the network site.

19. The method of claim 18 and further comprising:
searching each external uniform resource locator address for objectionable content in the address; and
wherein searching each hypertext markup language file to identify objectionable content includes identifying any words, symbols, and image identifiers that are irrelevant, obscene or immoral relative to the purposes of the web site.

20. A network site monitoring system comprising:
an user interface configured for viewing network pages;
a network site configured for displaying content on at least one network page and for displaying at least one of an internal network page link and an external network page link; and
a content monitor configured for identifying network page links on the network site that are associated with objectionable content.

21. The system of claim 20 wherein the content monitor further comprises:
a link list compiler configured for compiling a list of network page links on a network site;
a content searcher configured for searching network pages for objectionable content;
an objectionable content database configured for providing a list of words; and
a response monitor configured for notifying a network site of a network page link associated with objectionable content.

22. A network site comprising:
at least one network page configured for displaying at least one of an internal network page link and an external network page link; and
a content monitor configured for identifying network page links on the network site that are associated with objectionable content.

23. A web site content monitor comprising:
means for identifying an objectionable web page link on a web site; and
means for responding to the identified objectionable web page link.

24. A web site monitor comprising:
a web page compiler configured for compiling a plurality of web page links on a web site; and
a content identifier configured for identifying whether any of the plurality of web page links are associated with objectionable content.

25. A network site content monitor comprising:
a link list compiler configured for compiling a list of network page links on a network site;
a content searcher configured for searching network pages associated with the network page links for objectionable content;
an objectionable content database configured for providing a list of at least one of words, symbols, and image identifiers; and
a response monitor configured for notifying a network site of a network page link associated with objectionable content.

26. The monitor of claim 25 wherein the content searcher further comprises:
a sublink module configured for searching network page sublinks found within the network page of a network page link.

27. The monitor of claim 25 wherein the content searcher further comprises:
a depth module configured for determining a number of degrees of sublinking that will be searched.

28. The monitor of claim 25 wherein the response monitor further comprises at least one of:
a link blocker configured for blocking user access to a network page link on the network site that contains objectionable content;
a web site notification module configured for notifying an administrator of the network site of network page links associated with objectionable content; and
a user notification module configured for notifying a user that a network page link on the network site is associated with objectionable content.

29. The monitor of claim 25 and further comprising at least one of:
a list of internal network page links of the network site; and
a list of external network page links of the network site.

30. A computer-readable medium having computer-executable instructions for performing a method of monitoring a network site, the method comprising:
searching a network site to identify any network page link on the network site that is associated with objectionable content; and
responding to the identification of any network page links associated with objectionable content.

31. The medium of claim 30 wherein searching the network site comprises:
searching at least one of an external web page link and an internal web page link on the network site.

32. The medium of claim 31 wherein responding to the identification comprises at least one of:
notifying an administrator of the network site of the identified network page link associated with objectionable content;
blocking the identified network page link from being activated from the network site; and
contacting an operator of the identified network page link to request removal of the objectionable content.

33. A computer-readable medium having computer-executable instructions for performing a method of monitoring a network site, the method comprising:
scanning a network site for any network page links and compiling a list of those links;
determining whether each network page associated with the listed links includes objectionable content; and
compiling a list of each network page identified as having objectionable content.

34. The medium of claim 33 wherein scanning a network site comprises:
scanning the network site for at least one of an internal network page links and an external network page link.

35. The medium of claim 33 wherein determining whether each page includes objectionable content comprises at least one of:
searching the listed network page links for network page sublinks and identifying any objectionable content in the network page sublinks and in any network pages associated with the network page sublinks; and
searching the network page for meta tags that include objectionable content.

36. The medium of claim 33 and further comprising at least one of:
notifying the administrator of network page links for network pages that include objectionable content; and
blocking users from activating network page links at the network site that are associated with objectionable content.

37. A computer-readable medium having computer-executable instructions for performing a method of monitoring a network site, the method comprising:
scanning every external network page link of a network site to identify each external network page associated with the network site;
activating each external network page link on the network site to access an external network page associated with the activated external network page link;
searching each external network page to identify objectionable content; and
notifying an administrator of each external network page that includes objectionable content.

38. The medium of claim 37 wherein the method further comprises:
searching each network page link, including a uniform resource locator address of the link, for objectionable content in the link; and.
wherein identifying objectionable content includes identifying any words, symbols, and image identifiers that are irrelevant, obscene or immoral relative to the purposes of the web site.

39. A computer-readable medium having computer-executable instructions for performing a method of monitoring a network site, the method comprising:
scanning every hypertext markup language file of the web site to identify each external uniform resource locator address on the network site;
activating each external uniform resource locator address on the network site;
searching each external hypertext markup language file produced by activation of each uniform resource locator address to identify objectionable content; and
notifying an administrator of the network site of each external html file that includes objectionable content and that was accessed by activating an external uniform resource locator address on the network site.

40. The medium of claim 39 wherein the method further comprises:
searching each external uniform resource locator address for objectionable content in the address; and
wherein searching each hypertext markup language file to identify objectionable content includes identifying any words, symbols, and image identifiers that are irrelevant, obscene or immoral relative to the purposes of the web site.
